(19) United States
(12) Patent Application Publication
(10) Pub. No.: US 2020/0341922 A1
(43) Pub. Date: Oct. 29, 2020

(54) ELECTRONIC APPARATUS PROTECTION DEVICE AND METHOD

(71) Applicant: LENOVO (Singapore) PTE. LTD., New Tech Park (SG)

(72) Inventors: Munefumi Nakata, Yokohama-shi (JP); Hideshi Tsukamoto, Yokohama-shi (JP); Takeshi Migita, Yokohama-shi (JP)

(21) Appl. No.: 16/855,167

(22) Filed: Apr. 22, 2020

(30) Foreign Application Priority Data
Apr. 25, 2019 (JP) 2019-084559

(51) Int. Cl. G06F 13/38; H02H 9/04

(52) U.S. Cl. CPC G06F 13/385; G06F 2213/0042; H02H 9/044; H02H 9/042

(57) ABSTRACT

Methods, apparatus, and computer program products for protecting electronic devices are disclosed herein. One method includes detecting that a first connection terminal unit of a protection device is connected to an electronic apparatus to be protected, detecting that a second connection terminal unit is connected to an unknown device, and suppling source power to the electronic apparatus to be protected from the unknown device via a power supply terminal in a state where a data communication terminal is physically cut off. Apparatus, and computer program products that include and/or perform the methods are also disclosed herein.

### FIELD

The subject matter disclosed herein relates to computing systems and more particularly relates to devices and methods for protecting electronic devices from unauthorized access.

### BACKGROUND

Conventionally, physical connectors, such as a connector used with Universal Serial Bus (USB) type-C interface, are usable for various applications such as supply of charging power, data communication, output of image data, etc. Frequently, people need to charge their devices and will plug these devices into any available interface, such as the previously mentioned USB type-C interface. However, there is the possibility that the interface, which is installed on the public place, may be for example, an unauthorized device which is installed by a malicious party with the intention to access the device without authorization, or to steal content from the device. The device may even be physically harmed from the malicious interface.

### BRIEF SUMMARY

Various examples provide electronic apparatus protection. In certain examples, an apparatus includes a first connection terminal unit which is configured to be connectable with an electronic apparatus to be protected by using a predetermined interface; and a second connection terminal unit which is configured to be connectable with an unknown device; a detection terminal configured to detect that the unknown device is connected to the apparatus protection device via mating terminals of the second connection terminal unit; and a data communication terminal configured to, in response to the detecting the unknown device, physically cut off data communication in the first connection terminal unit. Also disclosed are a method, and computer program product that include and/or are performed by the apparatus.

### BRIEF DESCRIPTION OF THE DRAWINGS

A more particular description of the examples briefly described above will be rendered by reference to specific examples that are illustrated in the appended drawings. Understanding that these drawings depict only some examples and are not therefore to be considered to be limiting of scope, the examples will be described and explained with additional specificity and detail through the use of the accompanying drawings, in which:

FIG. 1 is a first perspective view illustrating one example of an outer appearance of a dongle device according to certain examples of the present disclosure;

FIG. 2 is a second perspective view illustrating another example of the outer appearance of the dongle device according to certain examples of the present disclosure;

FIG. 3 is a diagram illustrating one example of terminals of a male-type connector;

FIG. 4 is a diagram illustrating one example of terminals of a female-type connector;

FIG. 5 is a diagram illustrating one example of a state where the dongle device according to certain examples is connected to a host apparatus;

FIG. 6 is a configuration diagram illustrating one example of a configuration of a protection system according to certain examples;

FIG. 7 is a functional block diagram illustrating one example of a function of the protection system according to certain examples;

FIG. 8 is a functional block diagram illustrating one example of a function of the protection system according to certain examples in a case where the male-type connector is inserted into the dongle device in an inverted state;

FIG. 9 is a diagram illustrating one example of processing of deciding supply of source power via a CC terminal; and

FIG. 10 is a functional block diagram illustrating one example of a function of a protection system according to certain examples of the present disclosure.

### DETAILED DESCRIPTION

In the following, an electronic apparatus protection device and an electronic apparatus protection method according to examples of the present disclosure will be described.

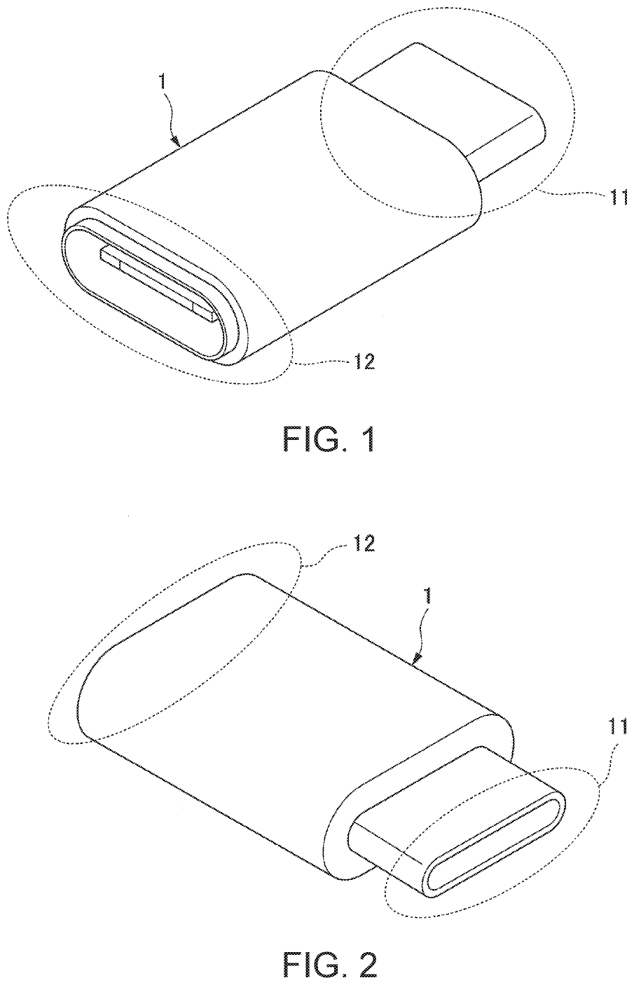

FIG. 1 and FIG. 2 are perspective views each illustrating one example of an outer appearance of a dongle device 1 according to certain examples of the present disclosure. As illustrated in FIG. 1 and FIG. 2, the dongle device 1 (one example of an electronic apparatus protection device) is, for example, a Universal Serial Bus (USB) dongle which has a USB type-C interface (one example of a predetermined interface). The dongle device 1 is configured to be connectable between an electronic apparatus to be protected (for example, a host apparatus 2 which will be described later) and an unknown or unauthorized device (for example, a device 4 which will be described later) by using the USB type-C interface.

In addition, as illustrated in FIG. 1 and FIG. 2, the dongle device 1 includes a male-type connector 11 and a female-type connector 12. Incidentally, FIG. 1 is the perspective view obtained in a case where the dongle device 1 is observed from the female-type connector 12 side and FIG. 2 is the perspective view obtained in a case where the dongle device 1 is observed from the male-type connector 11 side.

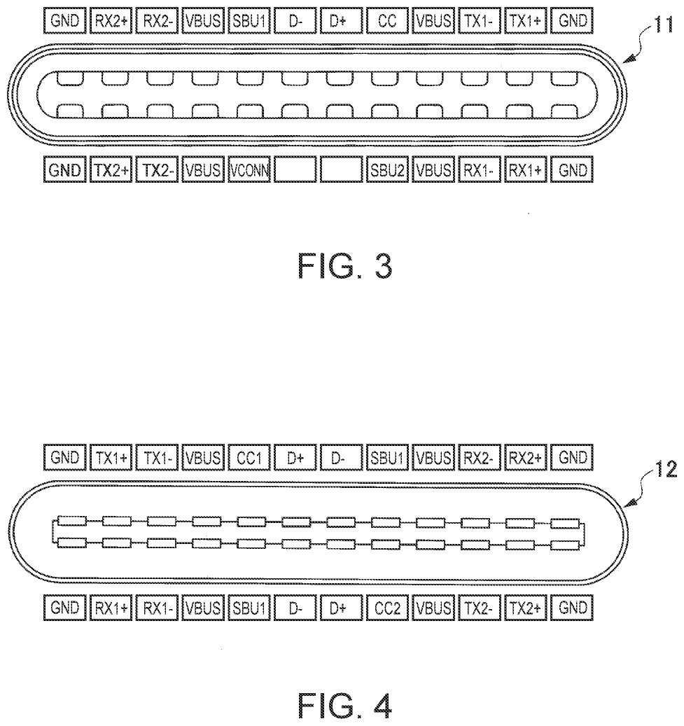

The male-type connector 11 (one example of a first connection terminal unit) is a protrusion-shape connector which is configured to be connectable with the electronic apparatus to be protected (for example, the host device 2) by using the USB type-C interface. For example, as illustrated in FIG. 3, the male-type connector 11 is a plug for female-type connection which has a plurality of connection terminals of the USB type-C interface.

FIG. 3 is a diagram illustrating one example of terminals of the male-type connector 11. As illustrated in FIG. 3, the male-type connector 11 has two, that is, upper and lower rows of terminals in a protrusion-shape and cylindrical connector. In the male-type connector 11, a ground (GND) terminal and a bus voltage (VBUS) terminal are power source supply terminals used for supplying source power.

In addition, data terminals (e.g., D+ terminal, a D− terminal), transmit terminals (e.g., a TX1+ terminal, a TX1− terminal, a TX2+ terminal, a TX2− terminal), receive terminals (e.g., RX1+ terminal, an RX1− terminal, an RX2+ terminal and an RX2− terminal) are data communication terminals which are used for performing data communication. In addition, a configuration channel (CC) terminal is a detection terminal which is used for detecting the unknown device which is connected with the electronic apparatus to be protected via the dongle device 1 together with a power terminal (e.g., VCONN terminal) which is used for power supply. In addition, a sideband use (SBU1) terminal and an SBU2 terminal are auxiliary terminals which are used for side bands.

Returning to the description in FIG. 1 and FIG. 2, the female-type connector 12 (one example of a second connection terminal unit) is a depression-shape connector which is configured to be connectable with the unknown device (for example, the device 4) by using the USB type-C interface. For example, as illustrated in FIG. 4, the female-type connector 12 is a receptacle for male-type connection which has a plurality of connection terminals of the USB type-C interface.

FIG. 4 is a diagram illustrating one example of terminals of the female-type connector 12. As illustrated in FIG. 4, the female-type connector 12 has a protrusion-shape connector in a depression-shape opening and has two, that is, upper and lower rows of terminals on the protrusion-shape connector. In the female-type connector 12, the terminals which are the same as the terminals of the male-type connector 11 are arranged so as to cope with usability (reversibility) even in a case where the male-type connector 11 is turned upside down (inside out). Incidentally, in the female-type connector 12, a CC1 terminal and a CC2 terminal are arranged in correspondence with the CC terminal of the male-type connector 11 so as to cope with the reversibility of the male-type connector 11.

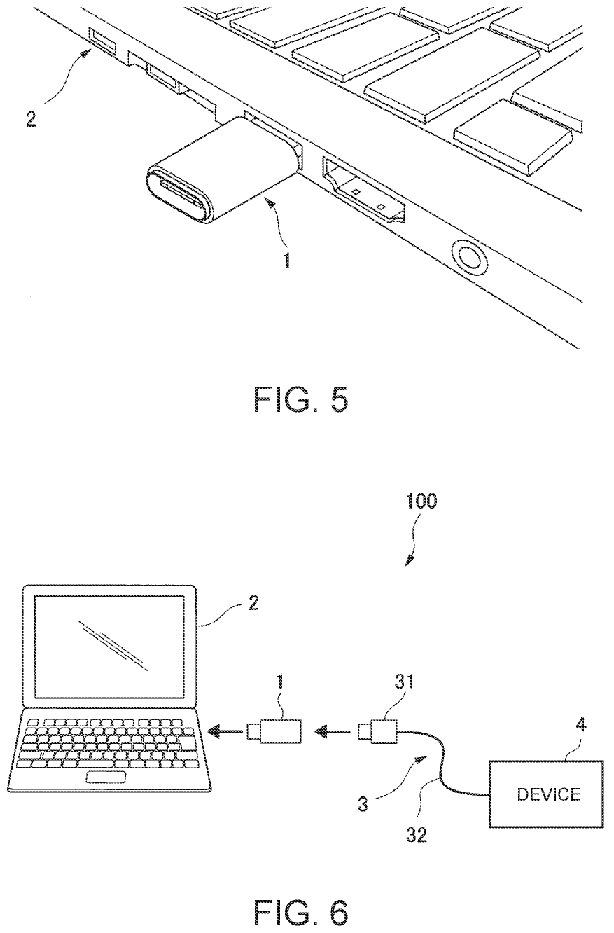

FIG. 5 is a diagram illustrating one example of the dongle device 1 which is connected to the host apparatus 2. As illustrated in FIG. 5, in a case where the dongle device 1 is to be connected (attached) to the host apparatus 2, the male-type connector 11 is inserted into a female-type connector (a receptacle which has the same shape as the female-type connector 12) of a USB type-C interface that the host apparatus 2 includes and thereby the dongle device 1 is connected to the host apparatus 2. The dongle device 1 is configured to be detachable relative to the host apparatus 2 in this way.

The power source supply terminals and the detection terminal of the male-type connector 11 are connected to mating terminals of the female-type connector 12 and the data communication terminals of the male-type connector 11 are physically cut off in the dongle device 1. Here, the power source supply terminals correspond to the ground (GND) terminal and bus voltage (VBUS) terminal and the detection terminal corresponds to the CC terminal. In addition, the data communication terminals correspond to the D+ terminal, the D− terminal, the transmit terminals (e.g., TX1+ terminal, the TX1− terminal, the TX2+ terminal, the TX2− terminal), the receive terminals (e.g., RX1+ terminal, the RX1− terminal, the RX2+ terminal and the RX2− terminal). Incidentally, details of the connection between the male-type connector 11 and the female-type connector 12 will be described later.

Next, a protection system 100 which uses the dongle device 1 according to certain examples will be described with reference to FIG. 6 to FIG. 8. FIG. 6 is a configuration diagram illustrating one example of a configuration of the protection system 100 according to certain examples. As illustrated in FIG. 6, the protection system 100 includes the dongle device 1, the host apparatus 2 and the device 4. The protection system 100 is a system which is adapted to protect the host apparatus 2 by using the dongle device 1.

The host apparatus 2 is an electronic apparatus such as, for example, a Laptop PC (a Laptop Personal Computer) and so forth and has the USB type-C interface. The device 4 is a power source supply device such as, for example, a common charger and so forth and corresponds to the unknown device. The device 4 has a USB type-C interface and supplies the source power to the electronic apparatus (the host apparatus 2) which is connected to the device 4 via a USB cable 3.

The USB cable 3 is a signal cable for the USB type-C interface and includes a connector unit 31 and a cable unit 32. The connector unit 31 is a male-type connector (plug) which is the same as the male-type connector 11 in shape.

As illustrated in FIG. 6, in the protection system 100, the dongle device 1 is connected between the host apparatus 2 to be protected and the unknown device 4. For example, the male-type connector 11 of the dongle device 1 is connected to the host apparatus 2 to be protected and the female-type connector 12 of the dongle device 1 is connected to the unknown device 4 via the USB cable 3. That is, the male-type connector 11 of the dongle device 1 is inserted into a female-type connector of the host apparatus 2 and the connector unit 31 of the USB cable 3 is inserted into the female-type connector 12 of the dongle device 1.

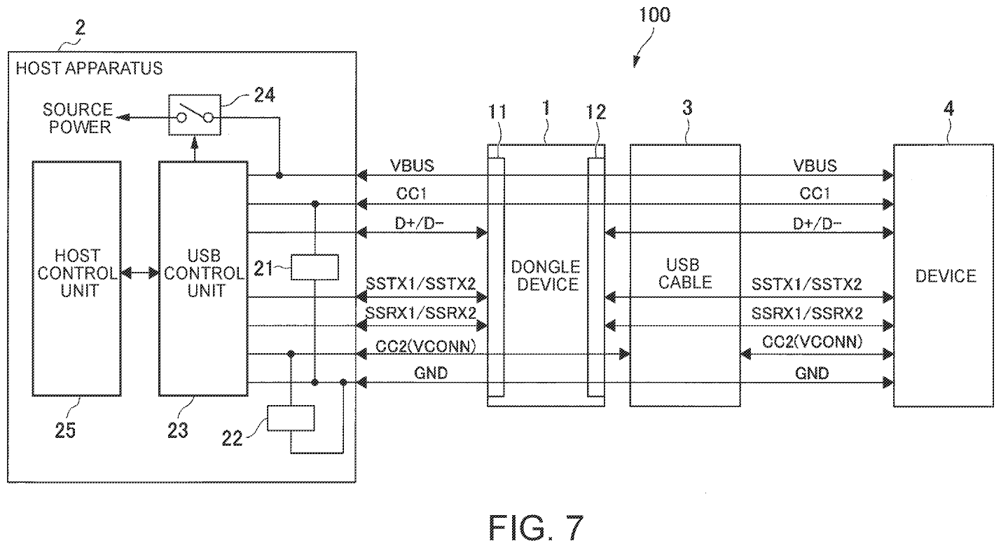

Next, details of the configuration of the protection system 100 according to certain examples will be described with reference to FIG. 7. FIG. 7 is a functional block diagram illustrating one example of a function of the protection system 100 according to certain examples. As illustrated in FIG. 7, the dongle device 1 is connected between the host apparatus 2 and the device 4 via the USB cable 3.

The VBUS terminal of the male-type connector 11 and the VBUS terminal of the female-type connector 12 are connected with each other and the GND terminal of the male-type connector 112 and the GND terminal of the female-type connector 12 are connected with each other between the male-type connector 11 and the female-type connector 12 of the dongle device 1. In addition, the CC terminal of the male-type connector 11 and the CC1 terminal of the female-type connector 12 are connected with each other and the VCONN terminal of the male-type connector 11 and the CC2 terminal of the female-type connector 12 are connected with each other.

Incidentally, in the example illustrated in FIG. 7, a CC1 terminal of the host apparatus 2 is connected to a CC terminal of the device 4 via the CC terminal of the male-type connector 11 and the CC1 terminal of the female-type connector 12 and a signal which is sent through a connection line concerned is called a CC1 signal (one example of a CC signal).

In addition, all mating terminals in the D+ terminals, the D− terminals, the TX1+ terminals, the TX1− terminals, the TX2+ terminals, the TX2− terminals, the RX1+ terminals, the RX1− terminals, the RX2+ terminals and the RX2− terminals are physically disconnected (cut off) between the male-type connector 11 and the female-type connector 12 of the dongle device 1. Incidentally, in FIG. 7, the TX1+ terminal and the TX1− terminal are denoted as an SSTX1 (i.e., super speed transmit) terminal and the TX2+ terminal and the TX2− terminal are denoted as an SSTX2 terminal. In addition, the RX1+ terminal and the RX1− terminal are denoted as an SSRX1 terminal and the RX2+ terminal and the RX2− terminal are denoted as an SSRX2 terminal.

The host apparatus 2 includes protection circuits (21, 22), a USB control unit 23, a switch unit 24 and a host control unit 25. The protection circuit 21 is a circuit for protecting the host apparatus 2 from overvoltage. In a case where the overvoltage is applied to a CC1 signal line (one example of a CC signal line) which is connected to the CC terminal (mating with the CC1 terminal of the female-type connector 12) of the male-type connector 11, the protection circuit 21 releases the applied overvoltage to the GND terminal and protects a component in the host apparatus 2 which is connected to the CC terminal from the overvoltage.

The protection circuit 22 is a circuit for protecting the host apparatus 2 from the overvoltage. In a case where the overvoltage is applied to a CC2 signal line (another example of the CC signal line) which is connected to the VCONN terminal (mating with the CC2 terminal of the female-type connector 12) of the male-type connector 11, the protection circuit 22 releases the applied overvoltage to the GND terminal and protects a component in the host apparatus 2 which is connected to the VCONN terminal from the overvoltage.

The USB control unit 23 controls the USB type-C interface of the host apparatus 2. The USB control unit 23 exchanges information relating to the source power which is supplied from device 4 with the device 4 by using, for example, the CC signal and executes processing of deciding the source power to be supplied from the device 4. In addition, the USB control unit 23 controls the switch unit 24 and permits supply of power into the host apparatus 2 for the purpose of utilizing the source power which is supplied from the device 4 in the host apparatus 2.

The switch unit 24 is a semiconductor switch such as for example, an FET (Field Effect Transistor) and so forth and operates to supply the source power which is supplied from the device 4 though a VBUS signal line USB of the USB type-C interface into the host apparatus 2 on the basis of control from the USB control unit 23.

The source power which is supplied from the device 4 via the dongle device 1 is utilized as, for example, the power to be charged into a battery (not illustrated) that the host apparatus 2 includes and the power for operating the host apparatus 2.

The host control unit 25 is a processor which includes, for example, a CPU (Central Processing Unit) and so forth and comprehensively controls the host apparatus 2. The host control unit 25 controls the USB control unit 23 when utilizing the USB type-C interface.

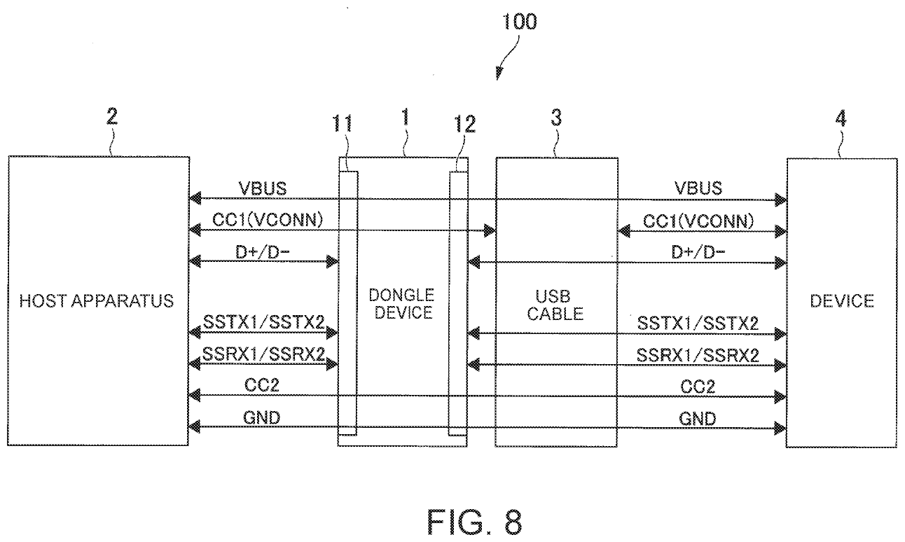

Next, one example of the protection system 100 in a case where the male-type connector 11 according to certain examples is inserted into the host apparatus 2 in a reversed state will be described with reference to FIG. 8. FIG. 8 is a functional block diagram illustrating one example of a function of the protection system 100 in a case where the male-type connector 11 according to certain examples is inserted into the host apparatus 2 in the reversed state. In the example illustrated in FIG. 7, the male-type connector 11 of the dongle device 1 is inserted into and connected with the female-type connector of the host apparatus 2 in a state of being turned upside down (reversed) from the state which is illustrated in FIG. 6.

In the example illustrated in FIG. 8, the CC terminal of the male-type connector 11 is connected with the CC2 terminal of the female-type connector 12 and the VCONN terminal of the male-type connector 11 is connected with the CC1 terminal of the female-type connector 12. That is, a CC2 terminal of the host apparatus 2 is connected with the CC terminal of the device 4 via the CC terminal of the male-type connector 11 and the CC2 terminal of the female-type connector 12 and a signal which is sent through a connection line concerned is called a CC2 signal (another example of the CC signal). Other connections are the same as the connections which are described with reference to FIG. 7.

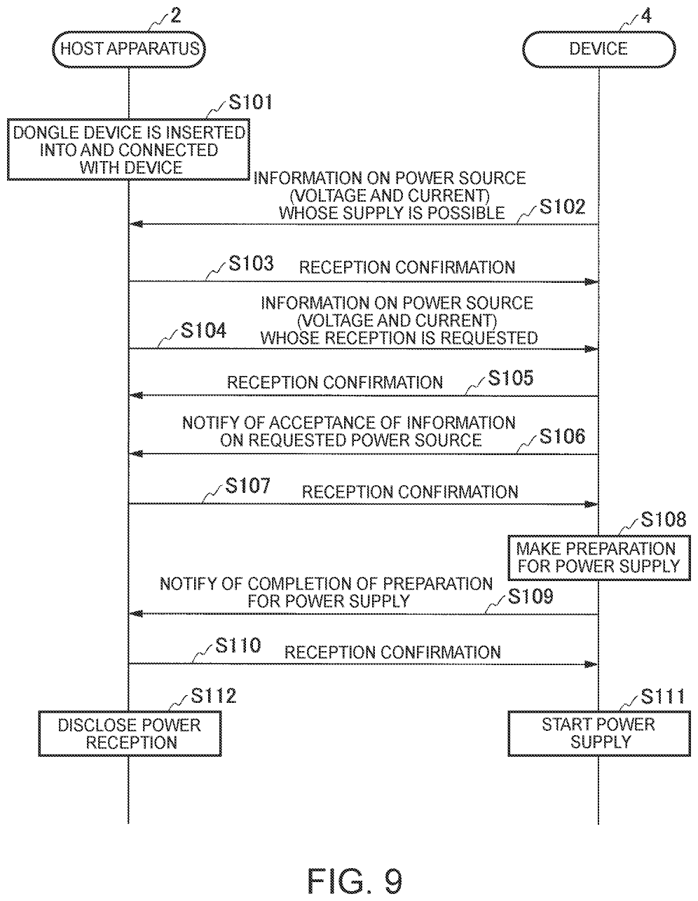

Next, operations of the dongle device 1 and the protection system 100 according to certain examples will be described with reference to the drawings. FIG. 9 is a diagram illustrating one example of processing of deciding supply of source power via the CC terminal in certain examples. In FIG. 9, the dongle device 1 is inserted into the host apparatus 2 and thereby the host apparatus 2 is connected with the device 4 (step S101). That is, the male-type connector 11 of the dongle device 1 is inserted into the host apparatus 2, further the connector unit 31 of the USB cable 3 of the device 4 is inserted into the female-type connector 12 of the dongle device 1 and thereby the host apparatus 2 is connected with the device 4 via the dongle device 1.

Next, the device 4 notifies the host apparatus 2 of information on power source (for example, a voltage and a current) that the device 4 itself is able to supply by using the CC signal (step S102). Next, in a case where the information on power source (for example, the voltage and the current) is normally received from the device 4, the host apparatus 2 transmits reception confirmation to the device 4 by using the CC signal (step S103). That is, in the case where the information on power source (for example, the voltage and the current) is normally received from the device 4 by using the CC signal, the USB control unit 23 of the host apparatus 2 transmits the reception confirmation to the device 4 by using the CC signal.

Next, the host apparatus 2 notifies the device 4 of the information on power source (for example, the voltage and the current) that the host apparatus 2 requests to receive by using the CC signal (step S104). The USB control unit 23 transmits the information on power source (for example, the voltage and the current) that the host apparatus 2 requests to receive by using the CC signal on the basis of the information on power source which is received from the device 4.

Next, in a case where the information on power source (for example, the voltage and the current) that the host apparatus 2 requests to receive is normally received from the host apparatus 2, the device 4 transmits reception confirmation to the host apparatus 2 by using the CC signal (step S105).

Next, the device 4 transmits a notice of acceptance of the information on power source that the host apparatus 1 requests to receive to the host apparatus 2 by using the CC signal (step S106). Next, in a case where the notice of acceptance of the information on power source is normally received, the host apparatus 2 transmits reception confirmation to the device 4 by using the CC signal (step S107). That is, in the case the notice of acceptance of the information on power source is normally received by using the CC signal, the USB control unit 23 transmits reception confirmation to the device 4 by using the CC signal.

Next, the device 4 makes preparations for power supply (step S108). That is, the device 4 executes preparations (for example, changing of various settings) for supplying the voltage and the current which are requested from the host apparatus 2. Next, the device 4 transmits a notice of completion of preparations for power supply to the host apparatus 2 by using the CC signal (step S109).

Next, in a case where the notice of completion of preparations for the power supply is normally received from the device 4, the host apparatus 2 transmits reception confirmation to the device 4 by using the CC signal (step S110). That is, in the case where the notice of completion of preparations for the power supply is normally received by using the CC signal, the USB control unit 23 transmits reception confirmation to the device 4 by using the CC signal.

Next, the device 4 supplies the voltage and the current which are requested from the host apparatus 2 to the host apparatus 2 via the dongle device 1 (step S111) and the host apparatus 2 starts reception of the source power (the voltage and the current) which is supplied from the device 4 (step S112). That is, the USB control unit 23 of the host apparatus 2 controls the switch unit 24 to an ON state and makes the dongle device 1 supply the source power (the voltage and the current) which is supplied from the device 4 into the host apparatus 2. For example, in a case where the host apparatus 2 includes the battery, the source power (the voltage and the current) which is supplied from the device 4 is utilized as charging power.

The dongle device 1 is connected between the host apparatus 2 to be protected and the unknown device 4 and the host apparatus 2 to be protected receives the source power from the unknown device 4 via the power source supply terminal in a state where the data communication terminals are physically cut off in this way.

As described above, the dongle device 1 (the electronic apparatus protection device) according to certain examples is the electronic apparatus protection device which is configured to be connectable between the host apparatus 2 to be protected (the electronic apparatus) and the unknown device 4 by using the predetermined interface and includes the male-type connector 11 (one example of the first connection terminal unit) and the female-type connector 12 (one example of the second connection terminal unit). The male-type connector 11 is configured to be connectable with the host apparatus 2 to be protected by using the predetermined interface (for example, the USB type-C interface). In addition, the female-type connector 12 is configured to be connectable with the unknown device 4 by using the predetermined interface (for example, the USB type-C interface). At the time of power supply, in the male-type connector 11 of the predetermined interface (for example, the USB type-C interface), the power source supply terminals and the detection terminal which is adapted to detect the device 4 which is connected to the host apparatus 2 are connected to the mating terminals of the female-type connector 12, and in the male-type connector 11 of the predetermined interface (for example the USB type-C interface), the data communication terminals which perform data communication are physically cut off. Here, the power source supply terminals are, for example, the VBUS terminal and the GND terminal of the USB type-C interface, the detection terminal is, for example, the CC terminal of the USB type-C interface. In addition, the data communication terminals are, for example, the D+ terminal, the D− terminal, the TX1+ terminal, the TX1− terminal, the TX2+ terminal, the TX2− terminal, the RX1+ terminal, the RX1− terminal, the RX2+ terminal and the RX2− terminal of the USB type-C interface.

Thereby, since in the dongle device 1 according to certain examples, the data communication terminals are physically cut off, for example, even in a case where the unknown device 4 which is to be connected with the host apparatus 2 to be protected (the electronic apparatus) is an unauthorized device which is installed by a malicious third person, data leakage and physical destruction of the electronic apparatus 2 are not performed. That is, in the dongle device 1 according to certain examples, for example, even in a case where a high voltage at which the host apparatus 2 would be destroyed is applied to the data communication terminals from the device 4, since the data communication terminals are physically cut off, it becomes possible to protect the host apparatus 2 from the high voltage. In addition, in the dongle device 1 according to certain examples, for example, even in a case where the device 4 attempts to install an unauthorized program into the host apparatus 2 via the data communication terminals and to read out secret data which is stored in the host apparatus 2, since the data communication terminals are physically cut off, it becomes possible to prevent data leakage.

In addition, since in the dongle device 1 according to certain examples, the power source supply terminals and the detection terminals are individually connected with each other between the host apparatus 2 and the device 4, for example, it becomes possible to appropriately accept supply of the source power (receive the source power) from the unknown device 4.

Accordingly, in the dongle device 1 according to certain examples, even in a case where the unauthorized device 4 is connected to the host apparatus 2, it becomes possible to appropriately protect the host apparatus 2 (the electronic apparatus). That is, it becomes possible for the dongle device 1 according to certain examples to charge the power safely by being connected to the unknown device 4 such as, for example, a charger and the like which are installed on a public place.

In addition, in certain examples, the predetermined interface is the USB type-C interface and the detection terminal is a USB type-C CC terminal. Incidentally, the USB type-C CC terminal is a terminal which detects connection between the host apparatus 2 and the device 4 and establishes an agreement for the source power which is supplied via the power source supply terminals between the host apparatus 2 and the device 4.

Thereby, since in the dongle device 1 according to certain examples, it is possible to appropriately set the source power to be supplied between the host apparatus 2 and the device 4 via the CC terminal, it becomes possible for the host apparatus 2 to appropriately accept supply of the source power.

In addition, in certain examples, the detection terminal is connected to the protection circuits (21, 22) which protect the host apparatus 2 from overvoltage. Thereby, in the dongle device 1 according to certain examples, even in a case where the unauthorized device 4 makes an attack by applying the overvoltage to the detection terminal (for example, the CC terminal) and so forth, it is possible to protect the host apparatus 2 from the overvoltage.

In addition, in certain examples, the electronic apparatus protection device is the dongle device 1 which is configured to be detachable relative to the host apparatus 2. Thereby, since the dongle device 1 according to certain examples is configured to be detachable, for example, in a case where the dongle device 1 is attached to the host apparatus 2 and used in a state where the host apparatus 2 is connected with the device 4 and then in a case where it becomes possible to confirm safety of the unknown device 4, it becomes possible to detach the dongle device 1 from the host apparatus and then to use the host apparatus 2 and the device 4 in a state of being connected with each other. That is, in the dongle device 1 according to certain examples, it is possible to detach the dongle device 1 from the host apparatus 2 for the device 4 the safety of which is confirmed and then to directly connect the host apparatus 2 with the device 4. Thereby, it becomes possible to cope with various applications other than the power supply and it becomes possible to improve convenience.

In addition, an electronic apparatus protection method according to certain examples is a method of protecting an electronic apparatus by using the dongle device 1 (the electronic apparatus protection device) which includes the male-type connector 11 which is configured to be connectable with the host apparatus 2 to be protected and the female-type connector 12 which is configured to be connectable with the unknown device 4 by using the predetermined interface (for example, the USB type-C interface). In the electronic apparatus protection method, in a state where the male-type connector 11 is connected with the electronic apparatus 2 to be protected, the female-type connector 12 is connected with the unknown device 4, thereby the dongle device 1 is connected between the host apparatus 2 to be protected and the unknown device 4 and then the data communication terminals are physically cut off, the host apparatus 2 to be protected accepts power source supply from the unknown device 4 via the power source supply terminals.

Thereby, the electronic apparatus protection method according to certain examples exhibits the same effects as the dongle device 1 and thereby it becomes possible to appropriately protect the host apparatus 2 (the electronic apparatus by the electronic apparatus protection method even in a case where the unauthorized device 4 is connected to the host apparatus 2.

In addition, the protection system 100 according to certain examples includes the host apparatus 2 and the dongle device 1. In a state where the dongle device 1 is connected between the host apparatus 2 to be protected and the unknown device 4 and the data communication terminals are physically cut off, the host apparatus 2 to be protected accepts the power source supply from the unknown or unauthorized device 4 via the power source supply terminals.

Thereby, the protection system 100 according to certain examples exhibits the same effects as the dongle device 1 and thereby it becomes possible to appropriately protect the host apparatus 2 (the electronic apparatus by the electronic apparatus protection system 100 even in a case where the unauthorized device 4 is connected to the host apparatus 2.

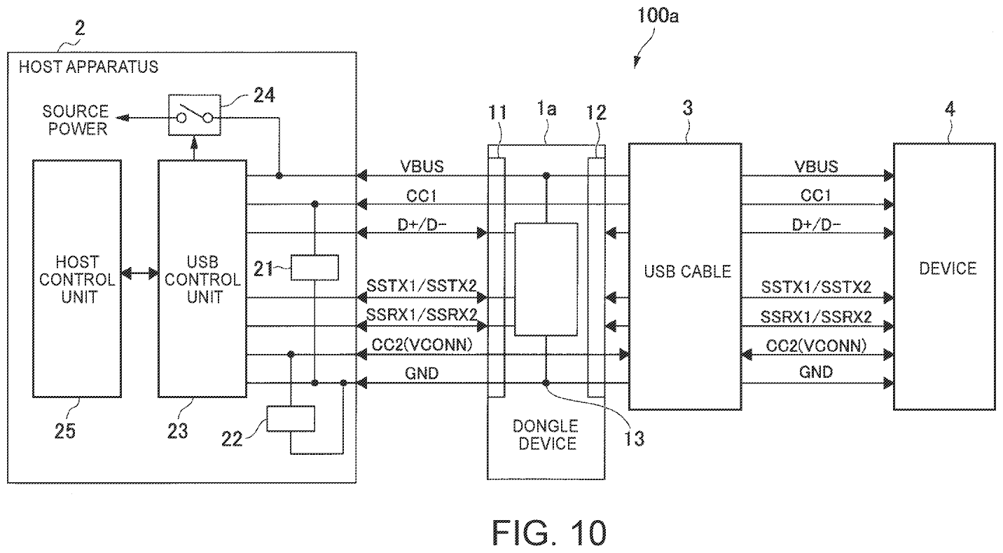

Next, a dongle device 1a and a protection system 100a according to certain examples will be described. In certain examples, a modified example that the dongle device 1a includes a function device unit such as a USB memory and so forth will be described. FIG. 10 is a functional block diagram illustrating one example of a function of the protection system 100a according to certain examples. As illustrated in FIG. 10, the protection system 100a includes the dongle device 1a, the host apparatus 2 and the device 4.

Incidentally, in FIG. 10, the same numerals are assigned to configurations which are the same as the configurations in FIG. 7 and description thereof is omitted. The dongle device 1a (one example of the electronic apparatus protection device) is connected between the host apparatus 2 and the device 4 via the USB cable 3. Incidentally, since the outer appearance of the dongle device 1a and the way of connecting the dongle device 1a with the host apparatus 2 and with the device 4 are the same as the outer appearance and the way of connecting the dongle device 1 with the host apparatus 2 and with the device 4 in certain examples which is illustrated in FIG. 1 to FIG. 6, description thereof is omitted here.

It is possible to connect the dongle device 1a between the host apparatus 2 (the electronic apparatus) to be protected and the unknown device 4 by using the USB type-C interface. In addition, the dongle device 1a includes the male-type connector 11, the female-type connector 12 and a USB device unit 13. The USB device unit 13 (one example of a function device unit) is, for example, a USB memory (a flash memory), a communication device unit such as a Bluetooth (a registered trademark)-based communication medium, a wireless LAN (Local Area Network) and so forth. The USB device unit 13 is connected to the data communication terminals of the male-type connector 11 and performs data communication with the host apparatus 2 via the data communication terminals by using the USB type-C interface. The USB device unit 13 is connected with, for example, signal lines of the VBUS terminal and the GND terminal and operates by accepting supply of the source power via the VBUS terminal and the GND terminal.

In addition, decision processing for power source supply via the CC terminal according to certain examples is the same as the decision processing in certain examples illustrated in FIG. 9 and therefore description thereof is omitted. As described above, the dongle device 1a according to certain examples includes the male-type connector 11, the female-type connector 12 and the USB device unit 13. At the time of power supply, in the male-type connector 11 of the predetermined interface, the power source supply terminals and the detection terminal which is adapted to detect the device 4 which is connected to the host apparatus 2 are connected to the mating terminals of the female-type connector 12 and in the male-type connector 11 of the predetermined interface, the data communication terminals which perform data communication are physically cut off.

Thereby, the dongle device 1a according to certain examples exhibits the same effects as the dongle device 1 according to certain examples and thereby it becomes possible to appropriately protect the host apparatus 2 (the electronic apparatus) by the dongle device 1a even in a case where the unauthorized device 4 is connected to the host apparatus 2.

In addition, in certain examples, the USB device unit 13 (one example of the function device unit) is connected to the data communication terminals of the male-type connector 11 and performs data communication with the host apparatus 2 via the data communication terminals by using the predetermined interface (for example, the USB type-C interface).

Thereby, the dongle device 1a according to certain examples appropriately protects the host apparatus 2 (the electronic apparatus) and it becomes possible to make the dongle device 1a junction as the USB device unit 13 (one example of the function device unit) which performs data communication with the host apparatus 2 via the data communication terminals. Accordingly, it becomes possible for the dongle device 1a according to certain examples to more improve the convenience.

Incidentally, the present disclosure is not limited to each of the examples and may be modified and altered in the range not deviating from the gist of the present disclosure. For example, although in each of the examples, the example that the predetermined interface is the USB type-C interface is described, the present disclosure is not limited to this example. The predetermined interface may be interfaces which are based on other specifications of the USB interface such as, for example, a Lightning (a registered trademark) interface, a micro USB interface and so forth.

In addition, although in each of the examples, the example that the electronic apparatus is the host device 2 such as the Laptop PC and so forth is described as one example of the electronic apparatus, the present disclosure is not limited to this example and the electronic apparatus may be other apparatuses such as, for example, a smartphone, a tablet terminal and so forth.

In addition, although in each of the examples, the example that the device 4 is the power source supply device such as the public charger and so forth is described as one example of the device 4 to which the host apparatus 2 is connected, the present disclosure is not limited to this example and the device may be other devices such as, for example, an unknown alternating current (AC) adapter and so forth.

In addition, although in each of the examples, the example that the host apparatus 2 includes the protection circuits (21, 22) is described, the present disclosure is not limited to this example and the dongle device 1 (1a) may include the protection circuits (21, 22).

In addition, although in each of the examples, the example that in the dongle device 1 (1a), the signal lines of the data communication terminals are physically disconnected (cut off) between the male-type connector 11 (one example of the first connection terminal unit) and the female-type connector (one example of the second terminal unit) is described, the present disclosure is not limited to this example. The dongle device 1 (1a) may include, for example, a changeover switch unit which is configured to be switchable with no influence on data communication so as to make it possible to use the dongle device 1 (1a) by switching a state between a state where the data communication terminals are physically disconnected (cut off) and a state where the data communication terminals are physically connected to the mating terminals by the changeover switch unit.

The host apparatus 2 and the device 4 include therein computer systems respectively. Then, the steps of the decision processing for power source supply which are performed by the CC terminal are stored in a computer-readable recording medium in the form of a program, the computer reads out and executes the program and thereby the decision processing is performed. Here, the computer-readable recording medium means a magnetic disc, a magneto-optical disc, a CD-ROM (Compact-Disk Read Only Memory), a DVD (Digital Versatile Disk)-ROM, a semiconductor memory and so forth. In addition, this computer program may be distributed to a computer via a communication line and the computer which receives the distributed program may execute the program.

Embodiments may be practiced in other specific forms. The described examples are to be considered in all respects only as illustrative and not restrictive. The scope of the technology is, therefore, indicated by the appended claims rather than by the foregoing description. All changes which come within the meaning and range of equivalency of the claims are to be embraced within their scope.

What is claimed is:

1. An apparatus protection device, comprising:
a first connection terminal unit which is configured to be connectable with an electronic apparatus to be protected by using a predetermined interface; and
a second connection terminal unit which is configured to be connectable with an unknown device;
a detection terminal configured to detect that the unknown device is connected to the apparatus protection device via mating terminals of the second connection terminal unit; and
a data communication terminal configured to, in response to the detecting the unknown device, physically cut off data communication in the first connection terminal unit.

2. The apparatus protection device of claim 1, where the predetermined interface is a USB (Universal Serial Bus) type-C interface.

3. The apparatus protection device of claim 2, where the detection terminal is a USB type-C CC terminal.

4. The apparatus protection device of claim 1, where the detection terminal is connected to a protection circuit which protects the electronic apparatus from overvoltage.

5. The apparatus protection device of claim 1, further comprising a function device unit which is configured to be connected to the data communication terminal of the first connection terminal unit.

6. The apparatus protection device of claim 5, where the function device unit is configured to perform data communication with the electronic apparatus by using the predetermined interface via the data communication terminal.

7. The apparatus protection device of claim 1, where the apparatus protection device is a dongle device which is configured to be detachable relative to the electronic apparatus.

8. A method comprising:
detecting that a first connection terminal unit of a protection device is connected to an electronic apparatus to be protected;
detecting that a second connection terminal unit is connected to an unknown device; and
suppling source power to the electronic apparatus to be protected from the unknown device via a power supply terminal in a state where a data communication terminal is physically cut off.

9. The method of claim 8, where the first connection terminal unit is configured to be connectable with the electronic apparatus using a predetermined interface.

10. The method of claim 9, where the predetermined interface is a USB (Universal Serial Bus) type-C interface.

11. The method of claim 9, further comprising detecting that the unknown device is connected to the protection device via mating terminals of the second connection terminal unit.

12. The method of claim 9, where the protection device includes the power supply terminal and a detection terminal configured to detect the unknown device.

13. The method of claim 12, further comprising, in response to the detecting the unknown device, cutting off the data communication terminal in the first connection terminal unit of the predetermined interface.

14. The method of claim 12, further comprising protecting, via a protection circuit connected to the detection terminal, the electronic apparatus from overvoltage.

15. The method of claim 14, further comprising performing, via a function device unit coupled to the data communication terminal of the first connection terminal unit, data communications with the electronic apparatus.

16. The method of claim 8, further comprising, detaching the protection device from the electronic apparatus.

17. A computer program product including a computer-readable recording medium that stores a program executable by a processor, the executable program comprising code to cause the processor to perform steps comprising:
detecting that a first connection terminal unit of a protection device is connected to an electronic apparatus to be protected;
detecting that a second connection terminal unit is connected to an unknown device; and
suppling, in response to the detecting the connection to the unknown device, source power to the electronic apparatus to be protected from the unknown device via a power supply terminal in a state where a data communication terminal is physically cut off.

18. The computer program product of claim 17, where the steps further comprise detecting that the unknown device is connected to the protection device via mating terminals of the second connection terminal unit.

19. The computer program product of claim 18, where the steps further comprise, in response to the detecting the unknown device, cutting off the data communication terminal in the first connection terminal unit of a predetermined interface.

20. The computer program product of claim 19, where the steps further comprise protecting, via a protection circuit connected to a detection terminal, the electronic apparatus from overvoltage.
